(19) United States
(12) Patent Application Publication
(10) Pub. No.: US 2019/0004238 A1
(43) Pub. Date: Jan. 3, 2019

(54) OPTICAL MODULE AND ILLUMINATION APPARATUS

(71) Applicant: Lite-On Technology Corporation, Taipei (TW)

(72) Inventors: Yao-Chi Peng, Taipei (TW); Kuo-Hui Chang, Taipei (TW); Po-Chang Li, Taipei (TW); Ming-Hung Chien, Taipei (TW)

(73) Assignee: Lite-On Technology Corporation, Taipei (TW)

(21) Appl. No.: 15/913,929

(22) Filed: Mar. 7, 2018

Related U.S. Application Data
(60) Provisional application No. 62/526,995, filed on Jun. 29, 2017.

(51) Int. Cl. F21V 8/00

(52) U.S. Cl. CPC G02B 6/0061; G02B 6/0055; G02B 6/0051; G02B 6/002; G02B 6/0043

(57) ABSTRACT

An optical module including a light guide plate and at least one secondary optical element is provided. The light guide plate has a first surface, a second surface opposite to the first surface, and a third surface connected between the first surface and the second surface. The at least one secondary optical element is disposed with the light guide plate and has a light entering surface and a light exit surface, wherein the light entering surface is connected to the first surface and forms a containing recess, and the light exit surface is connected to the second surface and protrudes from the second surface of the light guide plate. Besides, an illumination apparatus is also provided.

### CROSS-REFERENCE TO RELATED APPLICATION

This application claims the priority benefit of U.S. provisional application Ser. No. 62/526,995, filed on Jun. 29, 2017. The entirety of the above-mentioned patent application is hereby incorporated by reference herein and made a part of this specification.

### BACKGROUND

### Technical Field

The invention generally relates an optical module and an illumination apparatus.

### Description of Related Art

Currently, lighting market is divided into two main categories: indoor and outdoor, wherein indoor lighting due to being closer to living situations has always been concerned with glare control, while outdoor lighting has been focused on developments of luminous efficiency and light energy distribution control. Most existing light-emitting diode (LED) outdoor lights on the market typically adopt the design of discrete light sources, and the user may easily feel dazzled and glared in terms of visual experience due to the point light source design of the LED, in which a tiny luminous area provides a very high luminous flux to form a very high brightness. For a typical LED being operated under 1 W, a luminance thereof is up to millions, and this feature is favorable for the optical efficiency of the light-emitting devices but will result in a less comfortable feeling to the human eyes. As the replacement rate of LED outdoor lighting gradually increases, lighting comfort has also been taken seriously.

Common designs include using a soft mask and using a traditional light guide plate to form a uniform luminous area. However, this uniform light source does not have light distributing capability. Since outdoor road lighting needs to adjust the light distribution to meet the requirements of road lighting regulations, whereas traditional methods for homogenizing the luminous surface will destroy the original light distribution. Therefore, even though the traditional light guide plate has a better uniformity performance, it is limited by its light form and cannot be used for outdoor lighting, especially the road lighting.

### SUMMARY

The invention provides an optical module and an illumination apparatus having both better uniformity performance and light distributing capability.

According to an embodiment of the invention, an optical module including a light guide plate and at least one secondary optical element is provided. The light guide plate has a first surface, a second surface opposite to the first surface, and a third surface connected between the first surface and the second surface. The at least one secondary optical element is disposed with the light guide plate and has a light entering surface and a light exit surface, wherein the light entering surface is connected to the first surface and forms a containing recess, and the light exit surface is connected to the second surface and protrudes from the second surface of the light guide plate.

According to an embodiment of the invention, an illumination apparatus including an optical module, at least one first light source and at least one second light source is provided. The optical module includes a light guide plate and at least one secondary optical element. The light guide plate has a first surface, a second surface opposite to the first surface, and a third surface connected between the first surface and the second surface. The at least one secondary optical element is disposed with the light guide plate and has a light entering surface and a light exit surface, wherein the light entering surface is connected to the first surface and forms a containing recess, and the light exit surface is connected to the second surface and protrudes from the second surface of the light guide plate. The at least one first light source is configured to emit a first light beam into the light guide plate. The at least one second light source is configured to emit a second light beam to the at least one secondary optical element, wherein the containing recess of the at least one secondary optical element contains one of the at least one second light source.

Based on the above, the optical module provided by one of the embodiments of the invention includes the light guide plate and the at least one secondary optical element. Since the light guide plate has a function of reducing an energy intensity contrast in a light source so as to reduce glare in human eye visual experience, and the secondary optical element has a function of providing a light distribution required for road lighting, thus achieving both the visual comfort and optical energy distribution requirements while maintaining the optical efficiency of the illumination apparatus. In this way, by combining the light guide plate with the secondary optical element, the optical module and the illumination apparatus having the foregoing optical module in the embodiments of the invention are capable of enlarging the luminous area, providing high uniformity light surface, maintaining light energy distribution required for road lighting, and maintaining high optical penetration efficiency.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic cross-sectional view of an illumination apparatus according to an embodiment of the invention.

FIG. 2 is a schematic top side view according to an embodiment of the invention.

FIG. 3 is a luminance distribution diagram according to the illumination apparatus of FIG. 1 and an illumination apparatus not having the light guide plate and the first light source when viewing along a direction tilted with respect to the optical axis of the second light source by 70 degrees.

FIG. 4 is a schematic cross-sectional view of an illumination apparatus according to an embodiment of the invention.

FIG. 5 is a luminance distribution diagram according to the illumination apparatus of FIG. 4 and the illumination apparatus not having the light guide plate and the first light source when viewing along a direction tilted with respect to the optical axis of the second light source by 70 degrees.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

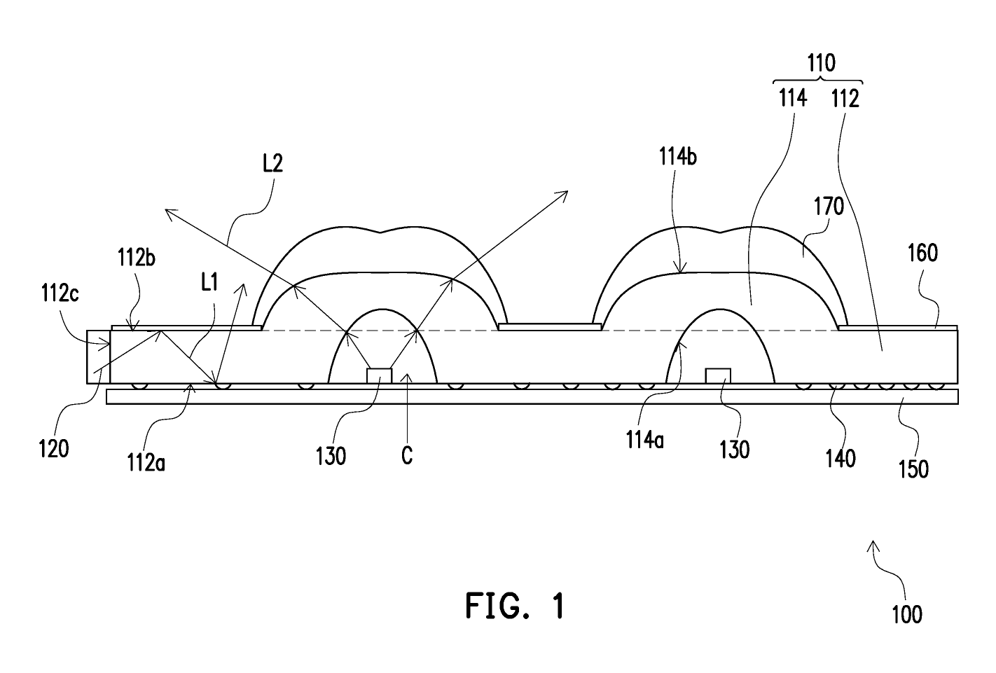

FIG. 1 is a schematic cross-sectional view of an illumination apparatus according to an embodiment of the invention. Referring to FIG. 1, an illumination apparatus 100 includes an optical module 110, at least one first light source 120 (for example, FIG. 1 illustrates one first light source 120) and at least one second light source 130 (for example, FIG. 1 illustrates two second light sources 130). The optical module 110 includes a light guide plate 112 and at least one secondary optical element 114 (for example, FIG. 1 illustrates two secondary optical elements 114). The light guide plate 112 has a first surface 112a, a second surface 112b opposite to the first surface 112a, and a third surface 112c connected between the first surface 112a and the second surface 112b. The at least one secondary optical element 114 is disposed with the light guide plate 112 and has a light entering surface 114a and a light exit surface 114b, wherein the light entering surface 114a is connected to the first surface 112a and forms a containing recess C, and the light exit surface 114b is connected to the second surface 112b and protrudes from the second surface 112b of the light guide plate 112.

In the present embodiment, the light guide plate 112 and the at least one secondary optical element 114 are integrally formed and made of a same material. In addition, the light entering surface 114a and the light exit surface 114b of the at least one secondary optical element 114 may be free-form surfaces, respectively.

The at least one first light source 120 is configured to emit a first light beam L1 into the light guide plate 112, wherein the first light beam L1 is transmitted in the light guide plate 112. The at least one second light source 130 is configured to emit a second light beam L2 to the at least one secondary optical element 114, wherein the containing recess C of the at least one secondary optical element 114 contains one of the at least one second light source 130. In the present embodiment, the at least one first light source 120 and the at least one second light source 130 may be, for example, light-emitting diodes, or other suitable light sources.

In the present embodiment, the first light source 120 is disposed beside the third surface 112c of the light guide plate 112. The optical module 110 further includes a plurality of optical microstructures 140 disposed on the first surface 112a of the light guide plate 112 and a reflector 150 disposed on the first surface 112a of the light guide plate 112, wherein the plurality of optical microstructures 140 are between the light guide plate 112 and the reflector 150. After the first light beam L1 emitted from the at least one first light source 120 enters the light guide plate 112, the first light beam L1 is totally internally reflected by the first surface 112a and the second surface 112b repeatedly, so that the first light beam L1 is confined in the light guide plate 112. However, the microstructures 140 break the total internal reflection and scatter the first light beam L1 to the second surface 112b or the reflector 150. Therefore, the first light beam L1 finally travels out of the light guide plate 112 through the second surface 112b of the light guide plate 112. Besides, the density of the plurality of optical microstructures 140 may gradually increase from a side adjacent to the first light source 120 to a side away from the first light source 120, so that a brightness difference between the side adjacent to first light source 120 and the side away from first light source 120 can be reduced. In the present embodiment, the reflector 150 may be a mirror reflector. For example, the reflector 150 can be a smooth metal layer or sheet, e.g. a silver color reflector. In addition, the reflector 150 may also be a diffusive reflector, e.g. a white reflector, but the invention is not limited thereto.

The first light beam L1 emitted from the at least one first light source 120 enters the light guide plate 112 through the third surface 112c, is guided by the light guide plate 112, and travels out of the light guide plate 112 through the second surface 112b in sequence. The second light beam L2 emitted from the at least one second light source 130 enters the at least one secondary optical element 114 through the light entering surface 114a and travels out of the at least one secondary optical element 114 through the light exit surface 114b. Since the light guide plate 112 has a function of reducing an energy intensity contrast in a light source so as to reduce glare in human eye visual experience, and the secondary optical element 114 has a function of providing a light distribution required for road lighting, thus achieving both the visual comfort and optical energy distribution requirements while maintaining the optical efficiency of the illumination apparatus 100. In this way, by combining the light guide plate 112 with the secondary optical element 114, the optical module 110 and the illumination apparatus 100 in the present embodiment are capable of enlarging the luminous area, providing high uniformity light surface, maintaining light energy distribution required for road lighting, and maintaining high optical penetration efficiency.

In the present embodiment, the optical module 110 can further include a diffusive layer 160 disposed on the second surface 112b of the light guide plate 112. The diffusive layer 160 makes light beams travel out of the light guide plate 112 more uniformly. In addition, the optical module 110 can further include a tail portion 170 disposed on a side of the secondary optical element 114 away from a road. The tail portion 170 can be used to reflect light beams toward the road, so that higher brightness can be provided for road lighting.

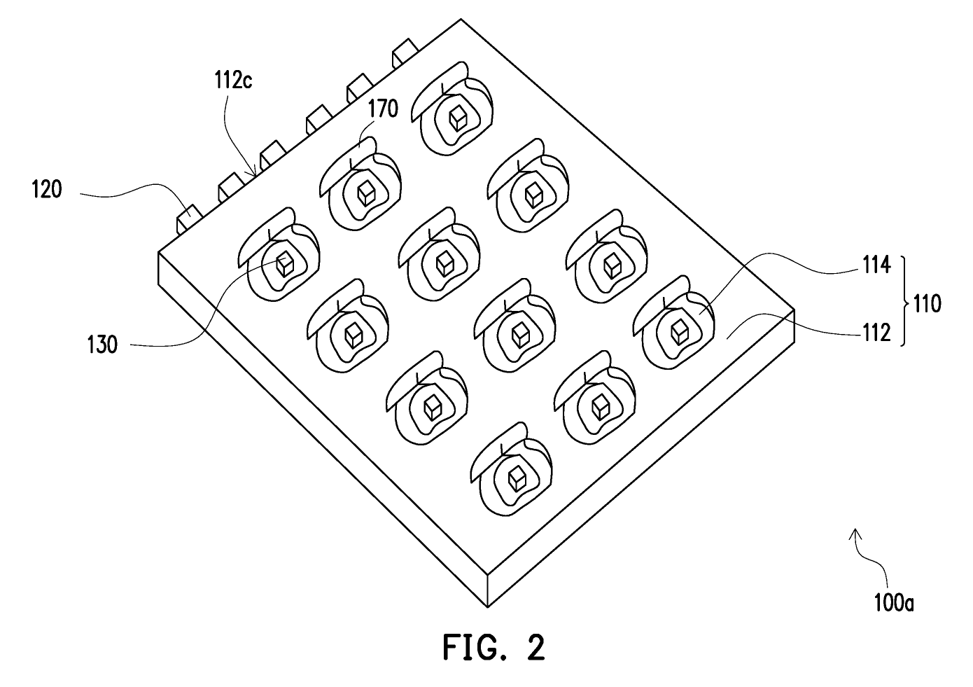

FIG. 2 is a schematic top side view according to an embodiment of the invention. Referring to FIG. 2, it should be noted that like or similar components are referred to by like or similar reference symbols, and the descriptions of like or similar components may be referred to the foregoing embodiment and are thus not repeated in the following. The illumination apparatus 100a of the present embodiment includes a plurality of first light sources 120 disposed on a side close to the tail portion 170 and arranged along the extension direction of the third surface 112c. In addition, the plurality of secondary optical elements 114 can be arranged in an array.

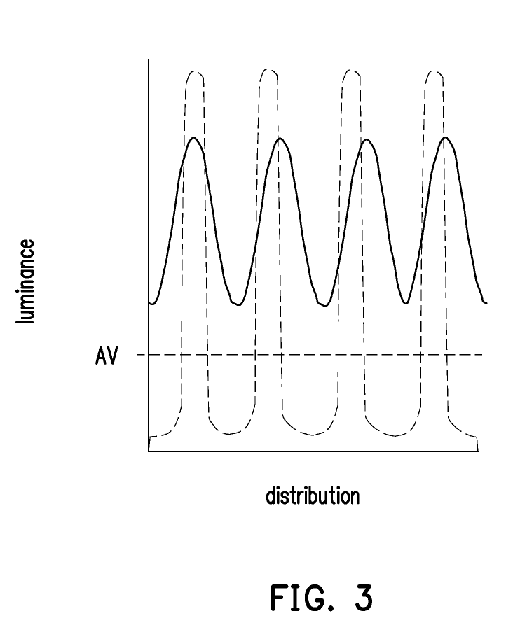

FIG. 3 is a luminance distribution diagram according to the illumination apparatus of FIG. 1 and an illumination apparatus not having the light guide plate and the first light source when viewing along a direction tilted with respect to the optical axis of the second light source by 70 degrees. Referring to FIG. 3, the luminance distribution diagram of the illumination apparatus 100 as illustrated in the FIG. 1 is represented by a solid line, while the luminance distribution diagram of the traditional illumination apparatus with an array of discrete light sources is represented by a dash line. The line AV represents the average luminance of the traditional illumination apparatus with an array of discrete light sources. As illustrated in FIG. 3, the ratio of maximum value to minimum value of the luminance of the illumination apparatus 100 is significantly reduced in comparison with that of the traditional illumination apparatus. Besides, the overall luminance of the illumination apparatus 100 is above the average luminance of the traditional illumination apparatus. That is to say, by combining the first light source 120 and the light guide plate 112 with the secondary optical element 114, the illumination apparatus 100 has a better uniformity performance and high optical penetration efficiency.

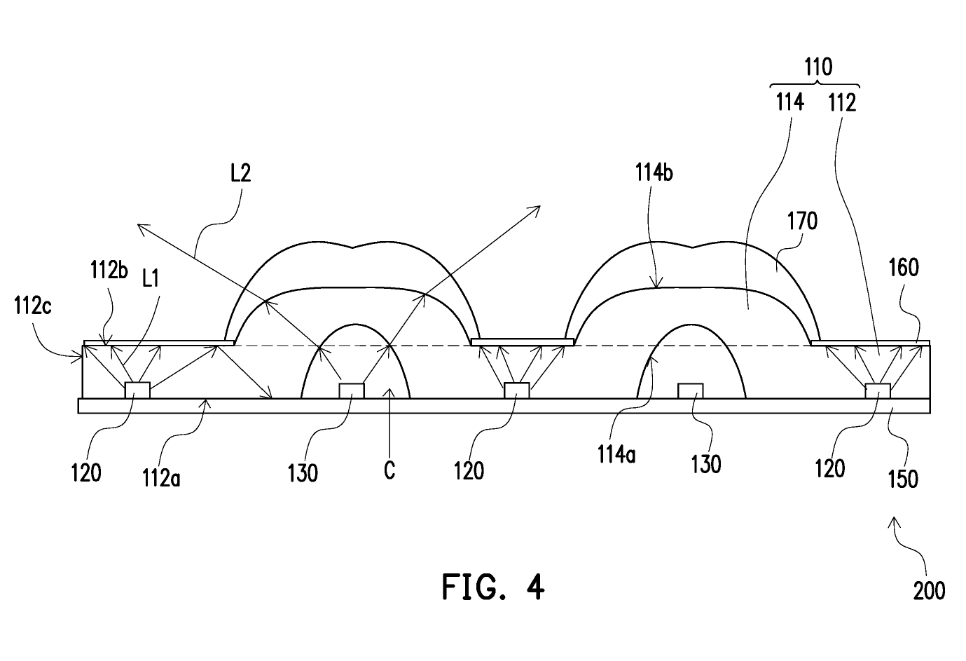

FIG. 4 is a schematic cross-sectional view of an illumination apparatus according to an embodiment of the invention. Referring to FIG. 4, an illumination apparatus 200 of the present embodiment is substantially similar to the illumination apparatus 100, and the differences therebetween are as follows. The illumination apparatus 200 has a plurality of first light sources 120. The first light source 120 of the illumination apparatus 100 is disposed beside the third surface 112c of the light guide plate 112, while the plurality of first light sources 120 of the illumination apparatus 200 are disposed inside the light guide plate 112 and are adjacent to the first surface 112a of the light guide plate 112. Namely, the first light sources 120 of the illumination apparatus 200 emit light directly inside the light guide plate 112. The first light sources 120 are disposed under corresponding diffusive layer 160. The first light beam L1 emitted from the first light sources 120 travels out of the light guide plate 112 through the second surface 112b and further passes through the diffusive layer 160.

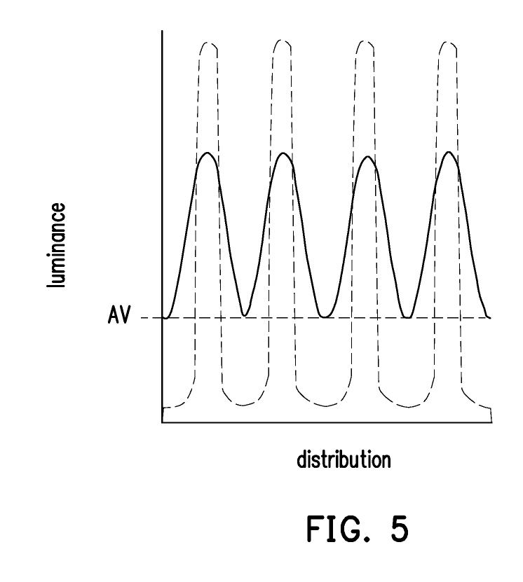

FIG. 5 is a luminance distribution diagram according to the illumination apparatus of FIG. 4 and the illumination apparatus not having the light guide plate and the first light source when viewing along a direction tilted with respect to the optical axis of the second light source by 70 degrees. Referring to FIG. 5, the luminance distribution diagram of the illumination apparatus 200 as illustrated in the FIG. 4 is represented by a solid line, while the luminance distribution diagram of the traditional illumination apparatus with an array of discrete light sources is represented by a dash line. The line AV represents the average luminance of the traditional illumination apparatus with an array of discrete light sources. As illustrated in FIG. 5, the ratio of maximum value to minimum value of the luminance of the illumination apparatus 200 is significantly reduced in comparison with that of the traditional illumination apparatus. Besides, the luminance of the illumination apparatus 200 is above the average luminance of the traditional illumination apparatus. That is to say, by combining the light guide plate 112 with the secondary optical element 114, the illumination apparatus 200 has a better uniformity performance and high optical penetration efficiency.

To sum up, the optical module provided by one of the embodiments of the invention includes the light guide plate and the at least one secondary optical element. Since the light guide plate has a function of reducing an energy intensity contrast in a light source so as to reduce glare in human eye visual experience, and the secondary optical element has a function of providing a light distribution required for road lighting, thus achieving both the visual comfort and optical energy distribution requirements while maintaining the optical efficiency of the illumination apparatus. In this way, by combining the light guide plate with the secondary optical element, the optical module and the illumination apparatus having the foregoing optical module in the embodiments of the invention are capable of enlarging the luminous area, providing high uniformity light surface, maintaining light energy distribution required for road lighting, and maintaining high optical penetration efficiency.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An optical module, comprising:
a light guide plate, having a first surface, a second surface opposite to the first surface, and a third surface connected between the first surface and the second surface; and
at least one secondary optical element, disposed with the light guide plate and having a light entering surface and a light exit surface, wherein the light entering surface is connected to the first surface and forms a containing recess, and the light exit surface is connected to the second surface and protrudes from the second surface of the light guide plate.

2. The optical module according to claim 1, wherein the light guide plate and the at least one secondary optical element are integrally formed and made of a same material.

3. The optical module according to claim 1, further comprising:
a plurality of optical microstructures, disposed on the first surface of the light guide plate.

4. The optical module according to claim 1, further comprising:
a reflector, disposed on the first surface of the light guide plate.

5. The optical module according to claim 1, wherein the reflector comprises a mirror reflector or a diffusive reflector.

6. The optical module according to claim 1, further comprising:
a diffusive layer, disposed on the second surface of the light guide plate.

7. The optical module according to claim 1, wherein the light entering surface and the light exit surface of the at least one secondary optical element comprises free-form surfaces, respectively.

8. An illumination apparatus, comprising:
an optical module, comprising:
a light guide plate, having a first surface, a second surface opposite to the first surface, and a third surface connected between the first surface and the second surface;
at least one secondary optical element, disposed with the light guide plate and having a light entering surface and a light exit surface, wherein the light entering surface is connected to the first surface and forms a containing recess, and the light exit surface is connected to the second surface and protrudes from the second surface of the light guide plate; and
at least one first light source, configured to emit a first light beam into the light guide plate; and
at least one second light source, configured to emit a second light beam to the at least one secondary optical element, wherein the containing recess of the at least one secondary optical element contains one of the at least one second light source.

9. The illumination apparatus according to claim 8, wherein the second light beam emitted from the at least one second light source enters the at least one secondary optical element through the light entering surface and travels out of the at least one secondary optical element through the light exit surface.

10. The illumination apparatus according to claim 8, wherein the light guide plate and the at least one secondary optical element are integrally formed and made of a same material.

11. The illumination apparatus according to claim 8, wherein the at least one first light source is disposed beside the third surface of the light guide plate.

12. The illumination apparatus according to claim 8, wherein the optical module further comprises:
a plurality of optical microstructures, disposed on the first surface of the light guide plate, wherein the density of the plurality of optical microstructures gradually increases from a side adjacent to the at least one first light source to a side away from the at least one first light source.

13. The illumination apparatus according to claim 11, wherein the first light beam emitted from the at least one first light source enters the light guide plate through the third surface and travels out of the light guide plate through the second surface.

14. The illumination apparatus according to claim 8, wherein the at least one first light source is disposed inside the light guide plate.

15. The illumination apparatus according to claim 14, wherein the first light beam emitted from the at least one first light source travels out of the light guide plate through the second surface.

16. The illumination apparatus according to claim 8, wherein the optical module further comprises:
a reflector, disposed on the first surface of the light guide plate.

17. The illumination apparatus according to claim 8, wherein the reflector comprises a mirror reflector or a diffusive reflector.

18. The illumination apparatus according to claim 8, wherein the optical module further comprises:
a diffusive layer, disposed on the second surface of the light guide plate.

19. The illumination apparatus according to claim 18, wherein the first light beam emitted from the at least one first light source passes through the diffusive layer.

20. The illumination apparatus according to claim 8, wherein the light entering surface and the light exit surface of the at least one secondary optical element comprise free-form surfaces, respectively.

21. The illumination apparatus according to claim 8, wherein the optical module further comprises:
a tail portion, disposed on a side of the secondary optical element.
